(19) United States
(12) Patent Application Publication
(10) Pub. No.: US 2026/0125047 A1
(43) Pub. Date: May 7, 2026

(54) VEHICLE WITH ROLLOVER ANGLE PREDICTION ON UNEVEN SURFACES

(71) Applicant: GM GLOBAL TECHNOLOGY OPERATIONS LLC, Detroit, MI (US)

(72) Inventors: Dustin Howard Malcom Smith, Clarkston, MI (US); Avesta Goodarzi, Whitby (CA)

(73) Assignee: GM GLOBAL TECHNOLOGY OPERATIONS LLC, Detroit, MI (US)

(21) Appl. No.: 18/939,661

(22) Filed: Nov. 7, 2024

(51) Int. Cl. B60W 30/04; B60W 10/18; B60W 10/20; B60W 50/00; B60W 50/14; B60W 60/00

(52) U.S. Cl. CPC B60W 30/04; B60W 10/18; B60W 10/20; B60W 50/0097; B60W 50/14; B60W 60/0015; B60W 2030/043; B60W 2050/146; B60W 2520/18

(57) ABSTRACT

A vehicle, system, and method includes receiving suspension data indicating a current state of suspensions of a vehicle, and estimating, by at least one processor, a height of a current center of gravity of the vehicle using at least the suspension data. The method then determines by at least one processor, a rollover limit angle prediction using the height of the current center of gravity. The method also includes performing, by at least one processor, an action to attempt to avoid a rollover of the vehicle depending on the rollover limit angle prediction.

### INTRODUCTION

The present disclosure relates to vehicles with off-road driving features, and more particularly, automatic rollover prediction for driving on uneven, rough surfaces.

When a vehicle is driven off-road, such vehicles are often intentionally driven over uneven, rocky, or severely angled dirt and unpaved vehicle trails. When one side of the vehicle is being driven over a much higher obstacle, such as a boulder, than the other side of the vehicle, or at a severely slanted trail, the vehicle may be driven at a banked angle. When such a banked angle is too large for the vehicle, the vehicle may roll onto its side or completely upside-down. Hence, an automatic, accurate, rollover angle prediction is desired to inform the driver of the vehicle before the rollover occurs.

### BRIEF SUMMARY

In an example implementation, a method includes receiving suspension data indicating a current state of suspensions of a vehicle, and estimating, by at least one processor, a height of a current center of gravity of the vehicle using at least the suspension data. The method then determines by at least one processor, a rollover limit angle prediction using the height of the current center of gravity. The method also includes performing, by at least one processor, an action to attempt to avoid a rollover of the vehicle depending on the rollover limit angle prediction.

Also in accordance with another example implementation, the action includes displaying an alert on the vehicle.

Also in accordance with another example implementation, the action includes displaying a current inclined angle of the vehicle and the rollover limit angle prediction of the vehicle.

Also in accordance with another example implementation, the method includes receiving data of a current absolute lateral angle indicating an inclined state of the vehicle and used to generate the height of the current center of gravity.

Also in accordance with another example implementation, the method includes determining a corner load of each wheel of the vehicle and includes using suspension deflections indicating wheel height and suspension stiffness of the suspension data.

Also in accordance with another example implementation, the method includes using the corner loads to generate a vehicle weight and the height of the current center of gravity of the vehicle.

Also in accordance with another example implementation, the generating of the height of the current center of gravity includes using the corner loads, a vehicle track width of the vehicle, and a current absolute lateral angle of the vehicle.

Also in accordance with another example implementation, the method includes generating a height of a center of gravity of a sprung mass of the vehicle includes generating a weight of sprung mass using a weight of the vehicle and a weight of unsprung mass, and using the height of the center of gravity of the sprung mass to generate the rollover limit angle prediction.

Also in accordance with another example implementation, the generating of the height of the center of gravity of the sprung mass includes using the weight of the vehicle, the height of the current center of gravity, the weight of unsprung mass, and the weight of sprung mass.

Also in accordance with another example implementation, the vehicle includes a chassis and wheels rotatably connected to the chassis, and the wheels are arranged to apply force to the suspensions. The method includes generating a roll gain that indicates a roll between the wheels and the chassis caused by the suspensions, and providing the roll gain to determine the rollover limit angle prediction.

In another example implementation, a system includes memory, and processor circuitry forming one or more processors being communicatively coupled to the memory, the processor being arranged to operate by: receiving suspension data indicating a current state of suspensions of a vehicle, estimating a height of a current center of gravity of the vehicle using at least the suspension data, determining a rollover limit angle prediction using the height of the current center of gravity, and performing an action to attempt to avoid a rollover of the vehicle depending on the rollover limit angle prediction.

Also in accordance with another example implementation, the determining comprises generating a current roll angle comprising using a vehicle track width and suspension deflections of the suspension data.

Also in accordance with another example implementation, the processor is arranged to operate by generating an existing bank angle comprising using the current roll angle and an existing absolute lateral angle of the vehicle.

Also in accordance with another example implementation, the vehicle includes a chassis and wheels rotatably connected to the chassis. The wheels are arranged to apply force to the suspensions, and the processor is arranged to operate by using the current roll angle and road bank angle to generate a roll gain that indicates a roll between the wheels and the chassis caused by the suspensions. The processor also is arranged to operate by providing the roll gain to determine the rollover limit angle prediction.

Also in accordance with another example implementation, the determining includes using a roll center height of the vehicle.

Also in accordance with another example implementation, the determining includes using a safety factor.

In another example implementation, a vehicle includes one or more controllers including memory and processor circuitry forming one or more processors communicatively coupled to the memory. The processor is to operate by receiving suspension data indicating a current state of the vehicle, and estimating a height of a current center of gravity of the vehicle using at least the suspension data. The processor also is to operate by determining a rollover limit angle prediction using the height of the current center of gravity, and performing an action to attempt to avoid a rollover of the vehicle depending on the rollover limit angle prediction.

Also in accordance with another example implementation, the action comprises displaying a rollover gauge with an image of an inclined vehicle at a current inclined angle.

Also in accordance with another example implementation, the action is displaying an alert on the vehicle when a detected current inclined angle is within an angle range of the rollover limit angle prediction.

Also in accordance with another example implementation, the action comprises at least one of: autonomously steering, autonomously accelerating, and autonomously braking of the vehicle to avoid the rollover.

### BRIEF DESCRIPTION OF THE DRAWINGS

The present disclosure will hereinafter be described in conjunction with the following figures. The figures are not to scale and numerals in the figures denote like elements, and where:

FIG. 1 is a schematic diagram of an example vehicle with a system to predict vehicle rollover angles according to at least one of the implementations herein;

FIG. 2 is a schematic diagram of an example vehicle rollover angle prediction system program of FIG. 1 and according to at least one of the implementations herein;

FIG. 3 is a flow chart of an example method of predicting a vehicle rollover angle according to at least one of the implementations herein;

FIG. 4 is a schematic diagram of a front of a vehicle in a setup of angles for computing a rollover limit angle prediction according to at least one of the implementations herein;

FIG. 5 is a schematic diagram of a front of the vehicle of FIG. 4 in a setup of variables used for computing the rollover limit angle prediction according to at least one of the implementations herein;

FIG. 6 is a flow chart of example vehicle rollover angle prediction algorithms used in the method of FIG. 3 according to at least one of the implementations herein;

FIG. 7 is a schematic diagram of an example display to inform a driver of a vehicle of a vehicle rollover angle according to at least one of the implementations herein;

FIG. 8 is a schematic diagram of another example display to inform a driver of a vehicle of a vehicle rollover angle according to at least one of the implementations herein;

FIG. 9 is a schematic diagram of yet another example display to inform a driver of a vehicle of a vehicle rollover angle according to at least one of the implementations herein;

FIG. 10 is a schematic diagram of a further example display to inform a driver of a vehicle of a vehicle rollover angle according to at least one of the implementations herein;

FIG. 11 is a schematic diagram of yet a further example display to inform a driver of a vehicle of a vehicle rollover angle according to at least one of the implementations herein.

### DETAILED DESCRIPTION

The following detailed description merely presents example implementations and is not intended to limit the disclosure or the application and uses thereof. Furthermore, no intention exists to be bound by any theory presented in the preceding background or the following detailed description.

During off-road driving, it is possible to roll a vehicle over when the center of gravity of the vehicle moves outside of the wheel track due to a banked orientation, and from left side to right side of the vehicle. A rollover limit angle is difficult to predict as it varies based on factors such as road bank angle, vehicle roll (or current banked state) angle, vehicle center of gravity (CG) height, suspension characteristics, cargo loading, number of passengers, tire selection by the end user, ride height, and so forth. The current vehicle roll angle can affect both the height and lateral position of the vehicle CG.

To resolve these issues, it has been found that the present vehicle, system, and method accurately predict rollover limit angles, also referred to as a form of maximum road bank angles. The predicted rollover limit angle enables an automatic action to inform the driver or occupant of the vehicle to avoid a rollover of the vehicle. This may be in the form of a display of gauges, warning lights, and/or other safety information systems to inform the driver about the current vehicle rollover limit angle. For example, this advanced warning may include automatically populating in-vehicle inclinometer gauges with roll limit angle values.

To generate the prediction of the rollover angle limit, this may involve estimating a center of gravity (CG) for a current rolled (or banked) state of the vehicle. By one form, this also involves using wheel position sensors, such as those at suspensions that measure the suspension travel, to also estimate precise vehicle roll angle, a roll gain, and corner loads. The proposed method then uses this information in correlation with measurable inertial measurement unit (IMU)-derived vehicle absolute lateral angle to adaptively predict the rollover limit angle. For clarity, the term ‘rolled’ as used herein refers to the vehicle being inclined from side to side or in a banked position, rather than a rollover position, which refers to the vehicle being on its side or upside-down so that the vehicle cannot usually move using its wheels.

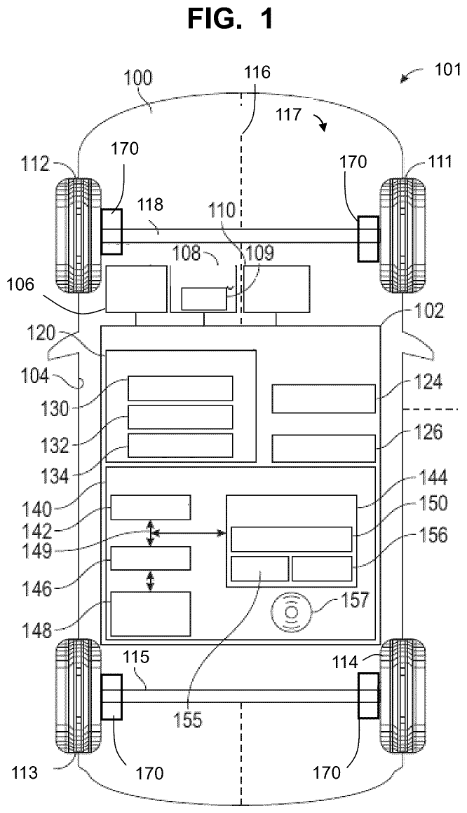

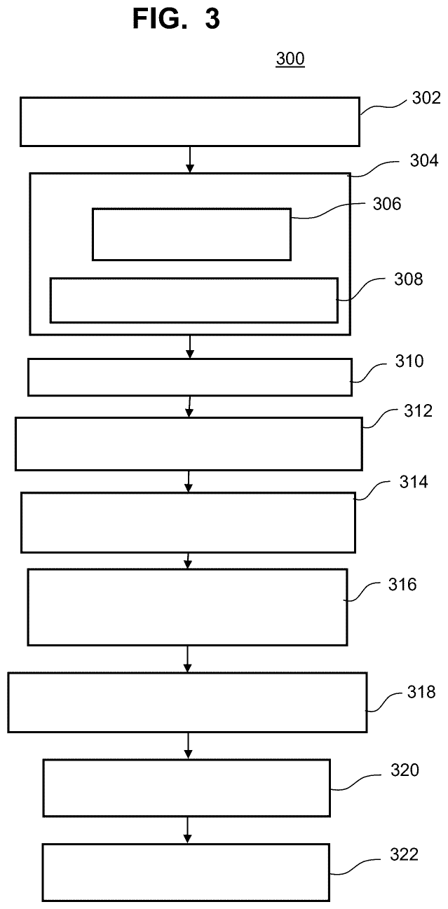

Referring to FIG. 1, a system 101 includes at least one vehicle 100 each to perform rollover limit angle prediction. In various implementations, the system 101 performs these tasks in accordance with a process 300 (FIG. 3) and the sub-processes and implementations thereof of FIGS. 1-2 and 4-11, in accordance with example implementations described herein. It should be noted that the term road, path, or trail is meant in a general sense herein to include any path that will be driven on by a vehicle including unpaved rough roads or trails, dirt trails, or any ground or terrain that an off-road vehicle with wheels can drive on. By one example the wheels of the vehicle touch the ground, but alternatively the vehicle may include tracks (such as crawler tracks), such as for military tanks or construction vehicles that have wheels moving or guiding the track and that use a suspension system as described herein.

By one example form, the vehicle 100 comprises an automobile. The vehicle 100 may be any one of a number of different types of automobiles, such as, for example, a sedan, a wagon, a truck, a jeep-type of vehicle, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain implementations such as trucks with more than four wheels, and so forth. Particularly for off-road, this also may include pickup trucks, all-terrain vehicles (ATVs), utility task vehicles (UTVs), off-road rigs, rock crawlers, desert trucks, lifted trucks, and so forth as well as the vehicles with tracks mentioned above. In certain implementations, the vehicle 100 may also comprise any other motorized vehicle with suspension sensors and inertial measure units (EIUs) that can detect the state of the suspension as well as an absolute angle of the vehicle.

In some implementations, the vehicle 100 may be operated in whole or in part by a human driver, or alternatively may comprise an autonomous or semi-autonomous vehicle, for example in which vehicle control (including acceleration, deceleration, braking, and/or steering) is automatically planned and executed by a control system 102 of the vehicle 100, in whole or in part. In addition, the vehicle 100 may be operated by a human at certain times and via automated control at other times. Thus, the vehicle 100 includes one or more functions that may be controlled automatically via the control system 102 to provide driver assistance features, for example.

Specifically, as described in greater detail further below, in various implementations, the vehicle 100 has a controller 140 (or computer system) with processor circuitry that forms at least one processor 142 and a memory 144 that stores programs 150 including software and/or firmware of a rollover limit angle prediction system and alerts as described in detail below.

Also, the example vehicle 100 includes a body 104 that is arranged on a chassis 117 and has a longitudinal central axis 116. The body 104 substantially encloses other components of the vehicle 100. The body 104 and the chassis 117 may jointly form a frame. The vehicle 100 also includes a plurality of wheels including a front left wheel 111, a front right wheel 112, a rear right wheel 113, and a rear left wheel 114, where right and left are from the driver's perspective. The wheels 111-114 are each rotationally coupled to the chassis 117 near a respective corner of the body 104 to facilitate movement of the vehicle 100.

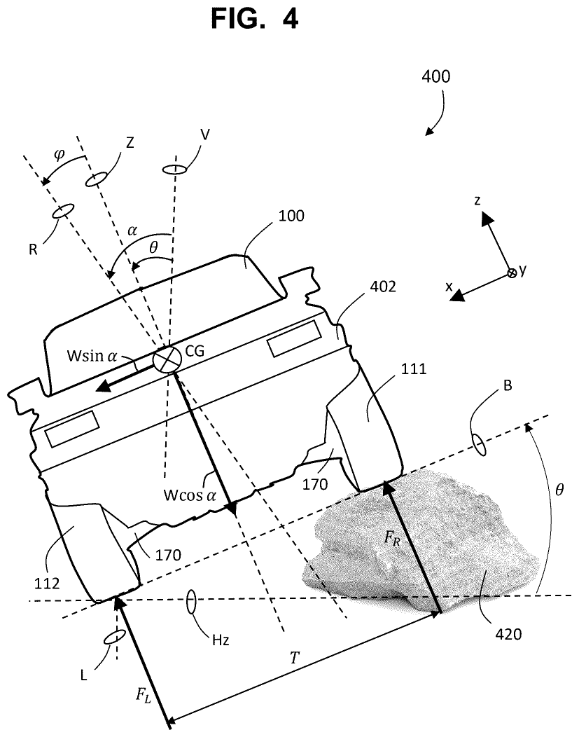

A drive system 110 is mounted on the chassis 117, and drives the wheels 111, 112, 113, and/or 114, for example via front and rear axles 118 and 115, respectively. A lateral wheelbase T (see FIG. 4) is defined from the right wheels 112 and 113 on one side to the left wheels 111 and 114 on the left side (where left and right are relative to the driver's perspective). The wheelbase T may be from center-to-center of the left-right tires as one example. The drive system 110 preferably has a propulsion system. In certain example implementations, the drive system 110 has an internal combustion engine and/or an electric motor/generator, coupled with a transmission thereof. In certain implementations, the drive system 110 may vary, and/or two or more drive systems 110 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

By some forms, the vehicle 100 also includes a braking system 106 and a steering system 108 with a steering wheel 109 and other components in various implementations and that may be controlled manually by the driver or autonomously.

By one approach, the control system 102 is coupled to the braking system 106, the steering system 108, and the drive system 110. In various implementations, the control system 102 at least facilitates the generating and processing of observational or perception data on camera images or detected by other sensors for the vehicle 100 and/or for other vehicles. In addition, in certain implementations in which the vehicle 100 is an autonomous or semi-autonomous vehicle, the control system 102 also provides in certain circumstances control over automated features of the vehicle 100 (including automated operation of the braking system 106, the steering system 108, and/or the drive system 110), including using one or more models that are trained using the perception data.

As depicted in FIG. 1, in various implementations, the control system 102 includes a sensor array 120, a display 124, a transceiver 126, and the controller 140. By one example, the sensor array 120 obtains sensor data for generating the observational or perception data. In various implementations, the sensor array 120 includes one or more cameras (or camera unit) 130 such as video cameras and/or still image cameras. Also in some examples, the sensor array 120 may also include one or more other detection sensors 132 (e.g., radar, sonar, light detection and ranging (LIDAR), infrared, or the like) and/or other sensors 134 (e.g., vehicle position sensors, speed sensors, accelerometers, gyroscopes, inertial sensors, braking sensors, steering sensors, suspension sensors, and so on). Relevant here, suspension sensors 134 used herein may be suspension height sensors or rotary position sensors with a linkage that connects to a suspension system.

By one example form, each wheel 111-114 has a suspension system (or collectively, suspensions) 170 with suspension components (or just a suspension) such as cylinders, pistons, springs, hydraulics, and so forth that attenuate impact loads from the wheels. This may include any suitable suspension as long as wheel travel sensors can be used to determine the position of the wheels, for example the height of the wheels compared to the chassis. This may include a MacPherson strut suspension, double wishbone suspension, leaf spring suspension, multi-link suspension, air suspension, coil spring suspension, torsion beam suspension, solid axle suspension, active and adaptive suspensions, and air ride suspension. The suspension systems 170 also each may have one or more of the suspension height sensors 134 that indicate a change in height of the suspensions as the suspensions expand or contract due to the height of a grade change in the road or trail. Thus, this in turn can indicate a corresponding change in height of any single wheel 111-114 relative to the chassis 117 and the other wheels 111-114, and therefore indicate the height of a grade change or incline from one wheel to another wheel.

In various implementations, the detection sensors 132 and/or other sensors 134 obtain additional information as to the roadway and/or the operation of the vehicle 100 itself (e.g., position, speed, deceleration and/or acceleration thereof, and so on) for use in operating the vehicle 100, for example in accordance with autonomous operation of the vehicle 100 and/or of certain components thereof. This may include radar sensors, ultrasonic, and other types of sensors as well as inertial measurement units (IMUs) that can detect the motion and orientation of a vehicle, such as a pitch angle forward and back and absolute lateral or roll angle from side to side. The IMU in conjunction with suspension measurements can be used to determine a current incline of the vehicle used to compute a rollover limit angle prediction. By other alternatives, however, in addition to, or alternatively to, the IMU alone, a camera-based system may be used to detect an incline of a roadway or trail upon which the wheels are sitting or driving. IN these cases, cameras may be positioned within wheel wells, or under the vehicle and toward the ground adjacent the wheels.

In these various camera assistance implementations, the cameras 130 used to obtain images of the observational or perception data of the road may include front, rear, side, and/or surround-view cameras including wide angle, 360 degree, and/or fish-eye lens cameras, as well as monocular, stereo, infrared, time-of-flight, thermal, LIDAR cameras, and so forth. These cameras 130 may capture images that are then processed by object detection algorithms that may be used to detect and measure a roadway or trail on which the vehicle 100 is operating and is able to detect shape and size (e.g., dimensions) of the trail surfaces, including boulders, rocks and other non-flat objects on or near a roadway, as well as other objects. Such imaging systems also may measure distances from the vehicle 100 to trail surfaces and other objects on the trail being driven on. In various implementations, video camera images are obtained. Additionally or alternatively, still camera images may be obtained.

By some examples, images captured by the cameras 130 are analyzed by one or more processors 142 to perform object detection and recognition algorithms such as those based on any one or more algorithms of: machine learning, neural networks, Convolutional Neural Networks (CNNs), Region-Based Convolutional Neural Networks (R-CNN), Recurrent Neural Networks (RNNs), Mask R-CNNs, You Only Look Once (YOLO), Single Shot MultiBox Detector (SSD), Semantic Segmentation such as Fully Convolutional Networks (FCNs) and U-Nets, for example, Haar Cascades (Viola-Jones (VJ) Detector), Histogram of Oriented Gradients (HOG), MOG (Mixture of Gaussians) background subtraction, Scale-Invariant Feature Transform (SIFT), Speeded-Up Robust Features (SURF), template matching, DPM (Deformable Parts Model), GMM (Gaussian Mixture Model) background subtraction, LDA (Linear Discriminant Analysis), and/or many others.

In the present example, the vehicle 100 also includes a transceiver 126 to communicate with remote systems, servers, devices, modules, or units. Thus, any parts or components (or units) of the control system 102 and/or controller 140 that performs processing for any of the operations described herein related to rollover limit angle prediction can be performed remotely when desired. Specifically, in various implementations, the controller 140 (and, in certain implementations, the control system 102 itself) is disposed within the body 104 of the vehicle 100. In one implementation, the control system 102 is mounted on the chassis 117. In certain implementations, the controller 140 and/or control system 102 and/or one or more components thereof may be disposed outside the body 104, for example on a remote server, in the cloud, or other device where image processing is performed remotely. It will be appreciated that the control system 102 and/or the controller 140 may otherwise differ from the implementation depicted in FIG. 1. For example, the controller 140 may be coupled to, or may otherwise utilize, one or more remote computer systems and/or other control systems, for example as part of one or more of the above-identified vehicle 100 devices and systems.

Also, the control system 102 may have a display on the vehicle 100 that can provide messages to occupants of the vehicle 100, such as alerts when the vehicle is rolling toward, or is banked near, a rollover limit angle. The display 124 may be any that can provide a screen for an occupant or user in the vehicle to see the images on the display 124. Such a display may be a digital display, a graphical user interface (GUI), an LED display, a plasma display, an LCD display, an organic light emitting diode (OLED) display, a thin-film transistor (TFT) display, heads up display (HUD), 3D displays, holographic displays, virtual or augmented displays, and so forth.

In various implementations, the controller 140 is coupled to the sensor array 120, as well as to the braking system 106, the steering system 108, and the drive system 110. In various implementations, the controller 140 is also coupled to the display 124 and the transceiver 126.

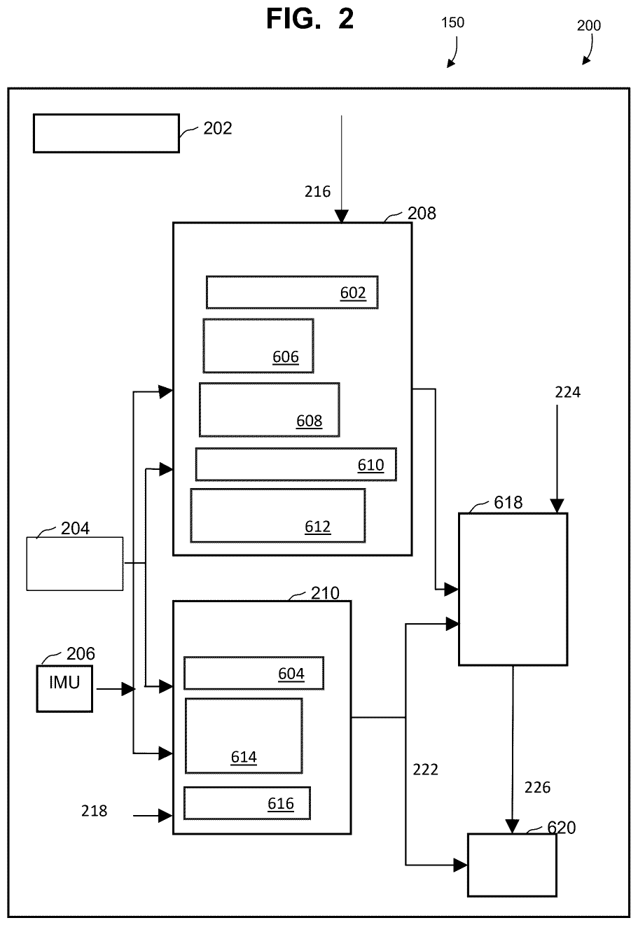

In various implementations, the controller 140 has, or is, a computer system, and includes the processor 142, the memory 144, an interface 146, a storage device 148, and a computer bus 149. In various implementations, the controller (or computer system) 140 obtains sensor data from the sensor array 120, and in certain implementations additional data via the transceiver 126. In various implementations, the controller 140 processes the suspension data, IMU data, and when provided perception data, including images of a roadway or trail up ahead on an expected path of the vehicle 100. In various implementations, the controller 140 provides these and other functions in accordance with the operations of the processes and implementations depicted in FIGS. 2-11 and as described further below in connection therewith.

In the depicted implementation, the controller 140 (or computer system) includes the processor 142 to perform the computation and control functions of the controller 140, and may comprise circuitry or circuits that form any type of processor or multiple processors including single integrated circuits such as a microprocessor, or any suitable number of integrated circuit devices and/or circuit boards working in cooperation to accomplish the functions of a processing unit. This may include a System on a Chip (SoC) and one or more processor cores. During operation, the processor 142 executes one or more programs 150 contained within the memory 144 and, as such, controls the general operation of the controller 140 and the computer system of the controller 140, generally in executing the processes described herein, such as the processes and implementations depicted in FIGS. 2-11 and as described further below in connection therewith.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted implementation, the memory 144 stores the above-referenced program 150 along with one or more databases 155 to store map and perception data and other stored values 156. The memory 144 also may store thresholds that are to be used for rollover limit angle prediction as described further below.

The bus 149 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one implementation, the interface 146 obtains the various data from the sensor array 120 and/or the navigation system 122. The interface 146 can include one or more network interfaces to communicate with other systems or components.

The storage device 148 can be any suitable type of storage apparatus, including various different types of direct access storage and/or other memory devices. In one example implementation, the storage device 148 comprises a program product from which memory 144 can receive the program 150 that executes one or more implementations of the processes and implementations of FIG. 3 and as described further below in connection therewith. In another example implementation, the program product may be directly stored in and/or otherwise accessed by the memory 144 and/or a secondary storage device (e.g., disk 157), such as that referenced below.

The bus 149 can be any suitable physical or logical arrangement of connecting computer systems and components. This includes, but is not limited to, direct hard-wired connections, fiber optics, infrared and wireless bus technologies. During operation, the program 150 is stored in the memory 144 and executed by the processor 142.

It will be appreciated that while this example implementation is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to conduct the distribution. Examples of signal bearing media include recordable media such as floppy disks, hard drives, memory cards and optical disks, and transmission media such as digital and analog communication links. It will be appreciated that cloud-based storage and/or other techniques may also be utilized in certain implementations. It will similarly be appreciated that the computer system of the controller 140 may also otherwise differ from the implementation depicted in FIG. 1, for example in that the computer system of the controller 140 may be coupled to or may otherwise utilize one or more remote computer systems and/or other control systems.

Referring to FIG. 2, a rollover limit angle prediction (RLAP) system 200 may be a program 150 that has units (also referred to as modules or components) that may be formed of any combination of software and/or firmware operated by processors 142 formed by hardware circuits described above. The hardware circuits may be shared hardware such as with a central processing unit (CPU), digital signal processor (DSP), and so forth. Otherwise, dedicated or specific function processors may be provided that operate neural networks, machine learning, and other structures for image processing for example, such as with graphical processing units (GPUs) or image signal processors (ISPs).

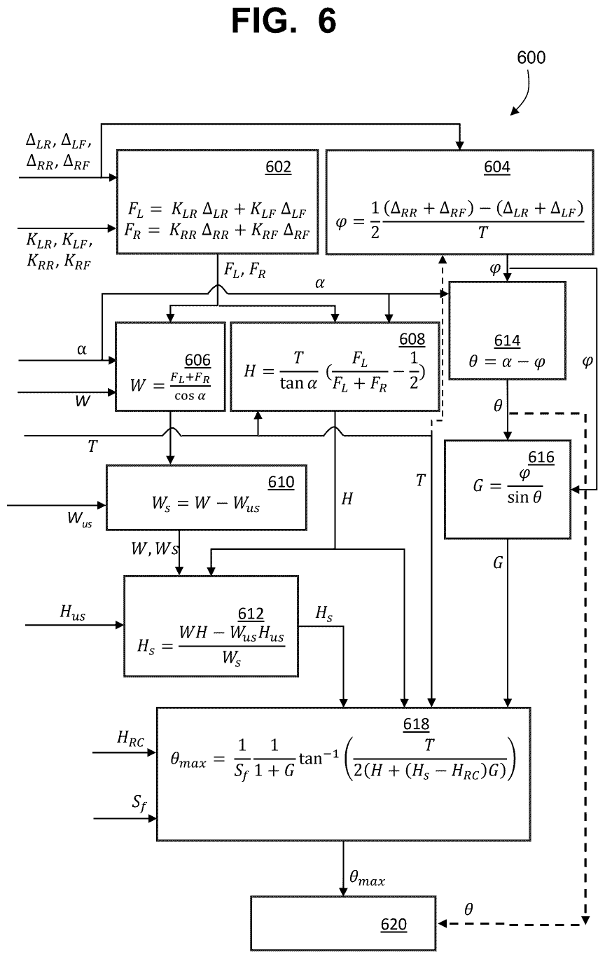

In the present example, the RLAP system 200 has an activation unit 202, a suspension deflections unit 204, an IMU unit 206, a corner load & center of gravity height estimation unit 208, an existing roll and bank angles unit 210, a rollover limit angle unit 618 (also shown on FIG. 6), and a rollover alert unit 620 (as on FIG. 6). In addition, other sub-components are the same as those of process 600 (FIG. 6, and are numbered accordingly) and as explained with process 300 (FIG. 3). Thus, the corner loads & CG height estimation unit 208 may have a load estimation unit 602, vehicle weight unit 606, a CG height estimation unit 608, a sprung mass weight unit 610, and a sprung CG height estimation unit 612. The existing roll and bank angles unit 210 may have a roll angle unit 604, existing road bank angle unit 614, and a roll gain unit 616.

In operation, the corner loads and CG height estimation unit 208 receives the suspension deflections from the suspension deflections unit 204 and the current absolute lateral angle of the vehicle from the IMU unit 206 (although by one possible option, the absolute lateral angles can additionally or alternatively be generated from use of image processing using the cameras mentioned above). The corner loads and CG height estimation unit 208 also receives the known vehicle/suspension parameters 216 including suspension stiffnesses, an unsprung mass weight of the vehicle, the vehicle track width, and the unsprung CG height. The corner loads and CG height estimation unit 208 uses these variables to generate the CG height of the vehicle and the sprung mass 220. The existing roll and bank angles unit 210 also receives the suspension deflections and absolute angles as well as vehicle parameters 218 including the vehicle track width. The existing roll and bank angles unit 210 then generates a roll gain (referred to as an existing roll and road bank) 222 that includes an additional vehicle rotation (or referred to as a roll angle) caused by the suspension and explained below. The rollover limit angle unit 618 receives known vehicle parameters 224 such as a roll center height and a safety factor as well as the roll gain 222 and the vehicle CG height and sprung mass 220, and then generates a rollover limit angle (or maximum road bank angle) 226. The rollover limit angle 226 then may be displayed to the driver by the rollover alert unit 620 or other automatic action may be taken by unit 620 depending on how close the rollover limit angle is to the actual inclined angle of the vehicle. The operation of these units and the mentioned factors and variables are described in detail below with processes 300 and 600.

Referring to FIG. 3, a process 300 of generating rollover limit angle predictions is provided according to at least one of the implementations described herein. The process 300 is described with operations 302-322 generally numbered evenly. The systems, processes, vehicles, devices, vehicle displays, and components of FIGS. 1-2 and 6-11 may be referred to where relevant.

The process 300 may include “activate rollover limit angle prediction system” 302. By one form, process 300 operates the RLAP system 200, and the RLAP system 200 is activated automatically as soon as the vehicle is turned on. Otherwise, the driver manually activates the RLAP system 200 by contacting an activator such as a physical switch, button, or virtual activator on a graphical user interface (GUI) on a display in the vehicle. Upon receiving an activation signal from any of these events, the activation unit 202 may immediately initiate the RLAP monitoring and computations, or the activation simply awakens the activation unit 202 to wait for additional triggers to begin the RLAP computations. By one example form, immediate monitoring for the RLAP may be performed, and the RLAP computations are performed whether or not the vehicle is moving. Otherwise, the RLAP monitoring may be set to start only when a non-zero minimum incline of the vehicle is detected. In these cases, the monitoring may begin when this inclined orientation is detected from the vehicle's sensors and/or IIU.

Once the RLAP system 200 is activated, the system 200 may perform continuous monitoring, such as by computing a rollover limit angle prediction every 10 milliseconds, or at least every 10 milliseconds, and by another example form, every 25 milliseconds. Otherwise, the monitoring may be less than 10 milliseconds or at least 25 milliseconds. By other forms, the driver or user may activate the RLAP system only when needed, such as on or entering a steep incline.

Process 300 may include “detect inclined vehicle state” 304, and that includes “detect absolute lateral angle” 306 performed by the IMU unit 206 and “determine suspension deflections” 308 performed by the suspension deflections unit 204 in this example. The monitoring for the inclined state of the vehicle can be performed by the IMU unit 206 and/or the camera unit 130 (which also may be an ADAS unit) or both.

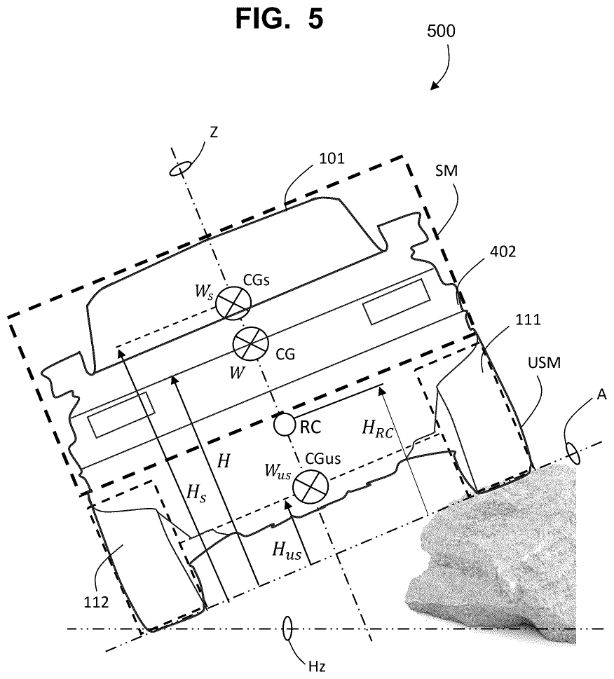

Referring to FIG. 4 for example, a vehicle setup 400 has a front 402 of the vehicle 100 shown traveling or stopped on an off-road trail or road and particularly with a left wheel 111 raised on a boulder 420 on the trail. The IMU unit 206 detects a total roll angle or absolute lateral angle α that includes both a current (or existing) trail or road bank angle θ and a roll angle cp caused by the suspension. Specifically, the current (or existing) trail or road bank angle θ is between true horizontal (or ground) Hz and a bank line B here extending at the bottom of wheels 111 and 112 of the vehicle 100. The vehicle 100 has a local xyz axes as shown where a Z-axis is through the height dimension of the vehicle and lateral middle of the vehicle. The Z-axis is different from a true vehicle axis V relative to true horizontal axis Hz. The bank angle θ is the angle of the vehicle between horizontal and the wheels or unsprung portion or mass (USM on FIG. 5) of the vehicle 100 that is supported by the wheels 111-114 and the ground.

The unsprung portion or mass (USM) of the vehicle 100 may include the tire, the wheels including the wheel hubs and bearings, axles and differential including the driveshafts and half-shafts, and the suspension components themselves not supported by the suspension and including control arms, shock absorbers, dampers, struts, sway bars, and any other vehicle component supported by the wheels but not the suspensions. Thus, the flexibility or stiffness of the suspensions 170 does not affect the bank angle θ. In contrast to unsprung mass, the sprung part or mass (SM on FIG. 5) of the vehicle includes all other components that are supported by the suspension such as the chassis and vehicle body that can roll relative to the wheels due to the suspension to cause the roll angle φ.

Another way the current incline of the vehicle is determined is by using the suspension deflections. The suspension deflections indicate the height change of the wheels 111-114 from a neutral position, and in turn the chassis. In this case, the suspension deflection unit 204 may receive sensor readings and compute deflections at each wheel 111-114 labeled herein as left rear Δ_{LR}, left front Δ_{LF}, right rear Δ_{RR}, right front Δ_{RF}. The deflections and ALAs indicate the current inclined state of the vehicle and are both provided to the other units of RLAP system 200 for further computations.

Process 300 may include “obtain vehicle parameters” 310, and from a memory accessible on the vehicle or remote from the vehicle. This may include obtaining vehicle parameters 216, 218, and/or 224 including the vehicle travel track width T that is a lateral width measured center-to-center of left and right wheels (here being front wheels 111 and 112) as shown on FIG. 4. Another known parameter for the vehicle is suspension stiffness coefficients K_{LR}, K_{LF}, K_{RR}, and K_{RF} that are part of suspension data, as well as an ‘unsprung mass’ weight W_{US} of the unsprung center of gravity (CG_{US}) and the unsprung height H_{US} of the CG_{US} (FIG. 5). Another parameter to be obtained is the roll center height H_{RC} of the vehicle 100 (also on FIG. 5). The parameters may be obtained from memory or other source by the unit that is to use the parameter or by a different unit RLAP of system 200 or controller 140.

Referring to FIG. 6, process 300 may include “determine center of gravity height using current deflections” 312, and as performed by the corner loads & CG height estimation unit 208. Specifically, this CG is referred to as the height H of the current center of gravity (CG) of the vehicle to differentiate from a height H_{US} of CG of unsprung mass and a height Hₛ of CG of sprung mass. Here, the load estimation unit 602 receives the suspension deflections and stiffness coefficients, and then uses equations (1) and (2) below to compute a left and right impact or corner load (or forces) F_{L} and F_{R} (FIG. 4) that combines corner loads for each left and right side of the vehicle.

$${F}_{L} = {K}_{LR} {Δ}_{LR} + {K}_{LF} {Δ}_{LF} \qquad ( 1 )$$

$${F}_{R} = {K}_{RR} {Δ}_{RR} + {K}_{RF} {Δ}_{RF} \qquad ( 2 )$$

Thereafter, the CG height estimation unit 608 uses the impact loads F_{L} and F_{R}, as well as the vehicle track width T and the absolute lateral angle α to compute the height H of the center of gravity of the vehicle, as shown on FIG. 5. The height H is computed as:

$$H = \frac{T}{tan α} ( \frac{{F}_{L}}{{F}_{L} + {F}_{R}} - \frac{1}{2} ) \qquad ( 3 )$$

The height H of the vehicle center of gravity is then provided to the sprung CG height estimation unit 612 and the rollover limit angle unit 212. The vehicle weight unit 606 determines the vehicle weight W (FIG. 5) by factoring the weight components along the vehicle Z-axis of W cos α (FIG. 4) and by using the impact loads F_{L} and F_{R} as follows:

$$W = \frac{{F}_{L} + {F}_{R}}{cos α} \qquad ( 4 )$$

The ‘spung mass’ weight Wₛ then may be determined by the ‘sprung mass’ weight unit 610 and by using the ‘unsprung mass’ weight W_{US} as follows:

$${W}_{s} = W - {W}_{us} \qquad ( 5 )$$

Process 300 may include “determine sprung center of gravity height using current deflections” 314, and performed by the sprung CG height estimation unit 612. This involves obtaining the CG height H_{US} (FIG. 5) as explained above, as well as the vehicle weight W, the vehicle CG height H, the unsprung mass weight W_{US}, and the sprung weight Wₛ. With these variables and/or factors, the sprung height of the sprung CG is computed as follows:

$${H}_{s} = \frac{WH - {W}_{us} {H}_{us}}{{W}_{s}} \qquad ( 6 )$$

The height of the sprung CG is then provided to the rollover limit angle prediction unit 618.

Next, process 300 may include “determine roll gain based on absolute roll angle and current deflections” 316 and performed by the existing roll and bank angles unit 210. This includes having the roll angle unit 604 use the suspension deflections and the vehicle travel width T to generate an existing or current roll angle as follows:

$$φ = \frac{1}{2} \frac{( {Δ}_{RR} + {Δ}_{RF} ) - ( {Δ}_{LR} + {Δ}_{LF} )}{T} \qquad ( 7 )$$

Referring to FIG. 4, the roll angle φ is between the inclined Z-axis of the vehicle and a suspension roll line R. As mentioned, the total outer roll of the vehicle 100 is the absolute lateral angle α detected by the IMU and/or by camera. The roll angle φ represents a portion of the absolute lateral angle α (or total outer roll) caused by the suspensions, and specifically the flexibility or stiffness of the suspensions that permits the vehicle body and chassis to roll relative to the wheels.

Once the roll angle φ is determined, the existing road bank angle unit 614 determines the existing road bank angle θ by subtracting the roll angle φ from the absolute lateral angle α as follows:

$$θ = α - φ \qquad ( 8 )$$

The road bank angle θ and the roll angle φ are then used to determine a ratio or proportional roll gain G that indicates the amount of suspension roll per road bank angle as follows:

$$G = \frac{φ}{sin θ} \qquad ( 9 )$$

Process 300 may include “determine rollover limit angle estimation” 318 and by the rollover limit angle unit 618, which receives the roll angle G as well as the height H of the center of gravity of the vehicle, the height Hₛ of the sprung center of gravity, the vehicle travel width T, the roll canter height H_{RC}, and a safety factor S_{f}. The safety factor S_{f} is a predetermined margin to better avoid a rollover, and may include 1.0. The rollover limit angle is then determined as:

$${θ}_{max} = \frac{1}{{S}_{f}} \frac{1}{1 + G} {tan}^{- 1} ( \frac{T}{2 ( H + ( {H}_{s} - {H}_{RC} ) G )} ) \qquad ( 10 )$$

By one example form, this equation determines where the vehicle CG represented by the vertical axis V shifts laterally and meets the lateral position L at the center of the bottom of the lower tire (here right wheel 112). Once the CG and vertical axis V shift more to the left and outside of the vehicle travel width T, the vehicle is highly likely to rollover. As mentioned, the process through equation (10) may be repeated so as to be continuous or may be performed at intervals or as needed as mentioned above.

Process 300 otherwise may include “compare limit angle to current angle” 320, where the rollover alert unit 620 makes the comparisons and determines if the angles are close enough to warrant an alert or other action. By one form, the difference in angles may be compared to a threshold for this determination. By one example, the rollover alert unit 620 may provide displays to the driver and process 300 may include “inform driver depending on comparison” 322. Additionally, or alternatively, the rollover alert unit may initiate autonomous driving commands to attempt to avoid a rollover and by providing brake, steering, and/or accelerator (or propulsion) commands to avoid the rollover. Other alternatives may include controlling an airbag inflation until the current vehicle angle (or ALA) becomes larger than the rollover limit angle prediction value. Many alternatives are contemplated.

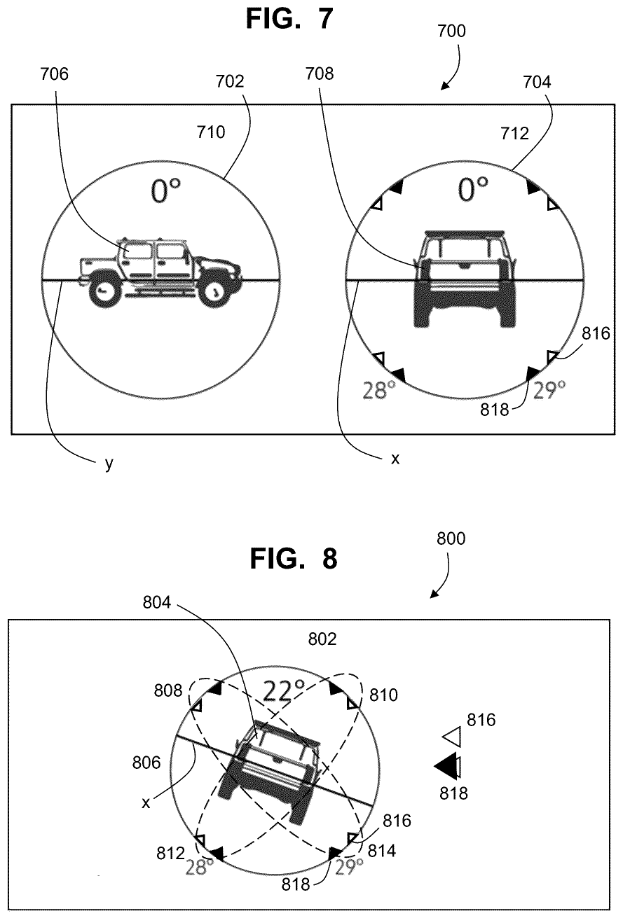

Referring to FIGS. 7-11 to provide examples of the alert displays, a rollover display 700 may be placed in a vehicle, such as on the dashboard of a vehicle, and may include both a pitch gauge 702 and a roll gauge 704. The pitch gauge shows a side of a vehicle 706 along a y-axis and with a current pitch angle of 0°. The pitch limit angle may be computed similarly to the roll limit angle as disclosed herein. By one form, the alert unit 620 shows the rollover displays as soon as the RLAP system 200 is activated. Alternatively, the system 200 may show the displays only when an alert or warning is indicated.

The roll gauge 704 shows a back of a vehicle 708 along an x-axis and with a current roll angle of 0°. Generated left and right rollover limit angles 28° and 29°, respectively, are indicated as well as triangular warning or caution indicators 816 (that are unfilled triangles) and triangular maximum road bank angle indicators 818 (that are filled triangles). The indicators are better explained with FIG. 8.

Thus, a display 800 has a rollover or roll gauge 802 with an image of an inclined vehicle 804 at a current inclined roll or angle 806 upon axis x. The current roll angle is 22°. The dashed ovals represent a right roll 808 and left roll 810 where the left roll maximum 812 (28°) and left roll 810 indicates a roll to the left, while the right roll maximum 814 (29°) and right roll 808 indicates a roll to the right. By one form, these maximum roll values are the computed rollover limit angle predictions. The warning indicator 818 indicates the rollover limit of the maximum road bank angle indicator 818. If the current angle is greater than the limit 818, the vehicle 804 is likely to rollover. The warning indicator 816 is set at a predetermined range of angles from the maximum angle indicator 818. Thus, a caution alert may be displayed to an occupant of the vehicle when a detected current roll angle is within the angle range of the rollover limit angle prediction, or in other words, between the warning indicator 816 and maximum angle indicator 818. By one form, the range is set at three degrees.

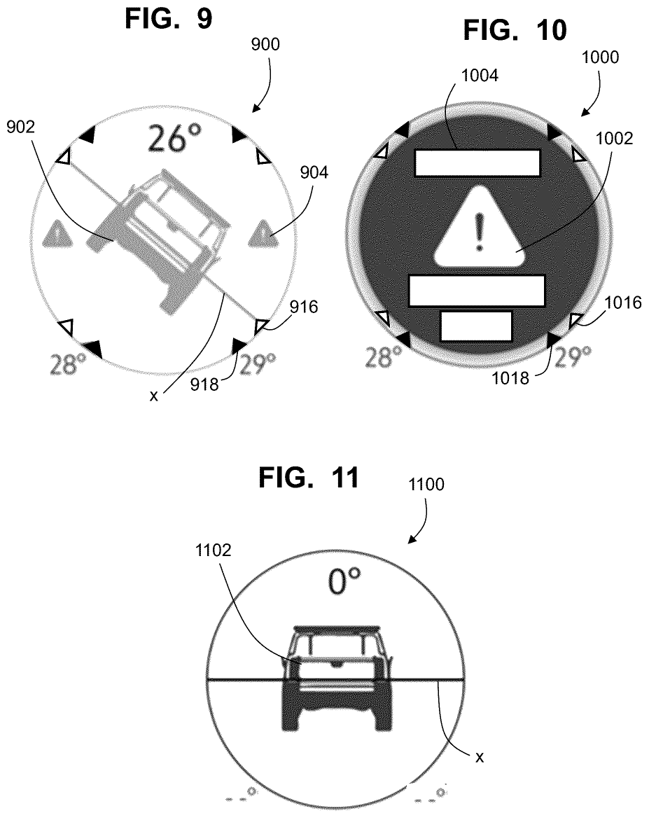

Referring to FIG. 9 a roll gauge 900 is shown, similar to roll gauge 802, but here a vehicle 902 is in a roll to the right at the maximum indicator 916, here being at 26° . or three degrees from the maximum 918 of 29°. In this case, further warning images 904 may be displayed, here being triangles with an exclamation point, where the fill or text of the images may be in red for example. Otherwise, the fill or the images, such as the vehicle itself, of the entire gauge may be set to another color, such as yellow for caution.

By another example, in a roll gauge 1000 (FIG. 10) the entire field of the gauge may turn red when the current incline angle reaches the maximum rollover angle 1018, and the warning image 1002 of the triangle with an exclamation may replace the image of the vehicle. Here too, the fill may be another color such as red another, or any desired combination of colors or patterns. Warning text 1004 may be placed within the gauge as well, and by one example stating “WARNING” AND “ROLLOVER RISK”, although many other words and phrases may be used instead.

By another example, a roll gauge 1100 (FIG. 11) shows a vehicle 1102 in a start or non-incline state where the current incline angle is 0° and no rollover limit angle predictions are shown. The RLAP system 200 may or may not be activated in this non-inclined state as mentioned above.

Herein, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements or parts of the nozzle do not imply that a direct physical connection must be made between these elements, unless mentioned otherwise. For example, two elements may be connected to each other physically, electronically, logically, or in any other manner, through one or more additional elements.

While at least one example implementation has been presented in the foregoing detailed description, it should be appreciated that a vast number of variations exist. It should also be appreciated that the example implementations are not intended to limit the scope, applicability, or configuration of the disclosure in any way. Rather, the foregoing detailed description will provide those skilled in the art with a convenient road map for implementing the example implementations. It should be understood that various changes can be made in the function and arrangement of elements without departing from the scope of the disclosure as set forth in the appended claims and the legal equivalents thereof.

1. A method, comprising:
receiving suspension data indicating a current state of suspensions of a vehicle in a current laterally inclined state, wherein the vehicle comprises a chassis and wheels rotatably connected to the chassis, and wherein the wheels are arranged to apply force to the suspensions;
estimating, by at least one processor, a height of a current center of gravity of the vehicle using at least the suspension data;
determining a current road bank angle that is obtained by subtracting a current roll angle from an absolute lateral angle of the vehicle in the inclined state;
generating a roll gain that indicates a roll between the wheels and the chassis caused by the suspensions, wherein the roll gain is a ratio of an amount of suspension roll per unit of vertical component of a tilted road grade causing the incline of the inclined state of the vehicle and as provided by the roll angle divided by sine of the current road bank angle;
determining, by at least one processor, a rollover limit angle prediction using the height of the current center of gravity, the roll gain, a height of a center of gravity of sprung mass of the vehicle, a height of a rolling center of the vehicle, and a safety factor; and
performing, by at least one processor, an action on the vehicle to attempt to avoid a rollover of the vehicle while the vehicle is in the inclined state and depending on the rollover limit angle prediction, wherein the action includes showing a display with all of:
a roll gauge with an image of an inclined vehicle having an orientation at the inclined state,
a warning indicator at an angle that indicates the vehicle is approaching close to the rollover limit angle prediction, and
a maximum road bank angle indicator to indicate the rollover limit angle prediction at which the vehicle is likely to roll,
wherein the action comprises at least one of: autonomously steering, autonomously accelerating, and autonomously braking of the vehicle to avoid the rollover.

2. The method of claim 1, wherein the action comprises displaying an alert on the vehicle.

3. (canceled)

4. The method of claim 1, wherein the current absolute lateral angle indicates the inclined state of the vehicle and is used to generate the height of the current center of gravity.

5. The method of claim 1, comprising determining a corner load of each wheel of the vehicle and comprising using suspension deflections indicating wheel height and suspension stiffness of the suspension data.

6. The method of claim 5, comprising using the corner loads to generate a vehicle weight and the height of the current center of gravity of the vehicle.

7. The method of claim 6, wherein generating the height of the current center of gravity comprises using the corner loads, a vehicle track width of the vehicle, and the current absolute lateral angle of the vehicle.

8. The method of claim 1, comprising generating the height of the center of gravity of the sprung mass of the vehicle comprising generating a weight of sprung mass by using a weight of the vehicle and a weight of unsprung mass.

9. The method of claim 8, wherein generating the height of the center of gravity of the sprung mass comprises using the weight of the vehicle, the height of the current center of gravity, the weight of unsprung mass, and the weight of sprung mass.

10. (canceled)

11. A system, comprising:
memory; and
processor circuitry forming one or more processors being communicatively coupled to the memory, the processor being arranged to operate by:
receiving suspension data indicating a current state of suspensions of a vehicle in a current laterally inclined state, wherein the vehicle comprises a chassis and wheels rotatably connected to the chassis, and wherein the wheels are arranged to apply force to the suspensions;
estimating a height of a current center of gravity of the vehicle using at least the suspension data,
determining a current road bank angle that is obtained by subtracting a current roll angle from an absolute lateral angle of the vehicle in the inclined state;
generating a roll gain that indicates a roll between the wheels and the chassis caused by the suspensions, wherein the roll gain is a ratio of an amount of suspension roll per unit of vertical component of a tilted road grade causing the incline of the inclined state of the vehicle and as provided by the roll angle divided by sine of the current road bank angle,
determining a rollover limit angle prediction using the height of the current center of gravity, the roll gain, a height of a center of gravity of sprung mass of the vehicle, a height of a rolling center of the vehicle, and a safety factor, and
performing an action on the vehicle to attempt to avoid a rollover of the vehicle while the vehicle is in the inclined state and depending on the rollover limit angle prediction, wherein the action includes showing a display with all of:
a roll gauge with an image of an inclined vehicle having an orientation at the inclined state,
a warning indicator at an angle that indicates the vehicle is approaching close to the rollover limit angle prediction, and
a maximum road bank angle indicator to indicate the rollover limit angle prediction at which the vehicle is likely to roll,
wherein the action comprises at least one of: autonomously steering, autonomously accelerating, and autonomously braking of the vehicle to avoid the rollover.

12. The system of claim 11, wherein the determining comprises generating the current roll angle comprising using a vehicle track width and suspension deflections of the suspension data.

13. (canceled)

14. (canceled)

15. The system of claim 11, wherein the determining comprises using a predetermined roll center height of the vehicle based on a configuration of the suspensions.

16. The system of claim 11, wherein the determining comprises using a safety factor that is a predetermined margin including 1.0.

17. A vehicle, comprising:
one or more controllers, comprising:
memory; and
processor circuitry forming one or more processors communicatively coupled to the memory, wherein the processor is to operate by:
receiving suspension data indicating a current state of suspensions of a vehicle in a current laterally inclined state, wherein the vehicle comprises a chassis and wheels rotatably connected to the chassis, and wherein the wheels are arranged to apply force to the suspensions;
estimating a height of a current center of gravity of the vehicle using at least the suspension data,
determining a current road bank angle that is obtained by subtracting a current roll angle from an absolute lateral angle of the vehicle in the inclined state;
generating a roll gain that indicates a roll between the wheels and the chassis caused by the suspensions, wherein the roll gain is a ratio of an amount of suspension roll per unit of vertical component of a tilted road grade causing the incline of the inclined state of the vehicle and as provided by the roll angle divided by sine of the current road bank angle,
determining a rollover limit angle prediction using the height of the current center of gravity, the roll gain, a height of a center of gravity of sprung mass of the vehicle, a height of a rolling center of the vehicle, and a safety factor, and
performing an action on the vehicle to attempt to avoid a rollover of the vehicle while the vehicle is in the inclined state and depending on the rollover limit angle prediction, wherein the action includes showing a display with all of:
a roll gauge with an image of an inclined vehicle having an orientation at the inclined state,
a warning indicator at an angle that indicates the vehicle is approaching close to the rollover limit angle prediction, and
a maximum road bank angle indicator to indicate the rollover limit angle prediction at which the vehicle is likely to roll.

18. The vehicle of claim 17, wherein the action comprises displaying a rollover gauge as the display with an image of an inclined vehicle at a current inclined angle.

19. The vehicle of claim 17, wherein the action is displaying an alert of different predetermined color or text or both on the vehicle when a detected current inclined angle is within an angle range of the rollover limit angle prediction.

20. The vehicle of claim 17, wherein the action comprises at least one of: autonomously steering, autonomously accelerating, and autonomously braking of the vehicle to avoid the rollover.

21. The method of claim 1, wherein the rollover limit angle prediction is road bank angle.

22. The method of claim 1, wherein the action comprises displaying two gauges one for pitch and one for roll of the vehicle.

23. The method of claim 1, wherein the action comprises displaying text that “states warning rollover risk”.

24. The method of claim 1, wherein the action comprises displaying an alert that has an icon with a triangle with an exclamation mark.
